(19) United States
(12) Patent Application Publication
(10) Pub. No.: US 2024/0071256 A1
(43) Pub. Date: Feb. 29, 2024

(54) Edema Simulation Device

(71) Applicant: Garett Conrad Craig, Canonsburg, PA (US)

(72) Inventor: Garett Conrad Craig, Canonsburg, PA (US)

(21) Appl. No.: 18/456,234

(22) Filed: Aug. 25, 2023

Related U.S. Application Data
(60) Provisional application No. 63/401,055, filed on Aug. 25, 2022.

(51) Int. Cl. G09B 23/30

(52) U.S. Cl. CPC G09B 23/303

(57) ABSTRACT

An edema simulation device features simulated skin above a plastic bag containing foam and a fluidized substance. The device is used to emulate swelling in tissues which may include adding or removing the fluidized substance from the bag via the syringe or the provision of distinct bags, with the purpose of better educating users on edema identification and staging. The simulated skin can be made of soft flexible elastic material that feels and reacts like skin. The plastic bag may be flexible, soft thin plastic sheet. The foam may be compressible, porous, soft material allowing fluid to perfuse through while retaining its general shape. The simulated skin, plastic sheet and foam can all vary in shape, size, thickness, hardness and colors. Adhesive layers or adaptors may be provided on the back of the device allowing selective attachment to table top displays, training mannequins or human simulated patients.

### RELATED APPLICATIONS

The present application claims the benefit of provisional patent application Ser. No. 63/401,055 filed Aug. 25, 2022 titled Edema Simulation Device which application is incorporated herein by reference.

### BACKGROUND OF THE INVENTION

### 1. Field of the Invention

This application relates to edema simulation devices and similar devices used to train and educate medical professionals in identification, staging and palpation of edema in the body.

### 2. Background Information

Edema, sometimes spelled oedema, and also known as fluid retention, dropsy, hydropsy and swelling, is the build-up of fluid in the body's tissue. Most commonly, the legs or arms are affected. Symptoms may include skin which feels tight, the area may feel heavy, and joint stiffness. Other symptoms depend on the underlying cause. For further background see Causes and signs of edema. Institute for Quality and Efficiency in Health Care (IQWiG). 2016; and “Edema—Cardiovascular Disorders. Merck Manuals Professional Edition. Retrieved 8 Dec. 2019. Causes may include venous insufficiency, heart failure, kidney problems, low protein levels, liver problems, deep vein thrombosis, infections, angioedema, certain medications, and lymphedema. It may also occur in immobile patients (stroke, spinal cord injury, aging), or with temporary immobility such as prolonged sitting or standing, and during menstruation or pregnancy. The condition is more concerning if it starts suddenly, or pain or shortness of breath is present. Treatment and symptoms generally depends on the underlying cause. For further background see Causes and signs of edema. Institute for Quality and Efficiency in Health Care (IQWiG). 2016; “Edema—Cardiovascular Disorders. Merck Manuals Professional Edition; and “Edema: Causes, Symptoms, Diagnosis & Treatment”. Family doctor.

There is a need for training medical professionals (also called healthcare professionals herein) to access edema in presenting patients. Classroom discussion alone is inadequate and extensive repetitive training on live patients in impractical due to the need for supervision for the trainees.

Edema simulators, and medical simulators in general, are a way to educate and train healthcare professional without the need to having real patients. Simulation mannequins are high tech devices that allow for users to train with human like models without the inherent risks of training on living patients. Simulation of edema with such mannequins is either highly expensive, the mannequins feature low compatibility with other brand edema trainer devices or simply do not have edema simulation capabilities.

Regarding existing devices, Joshua D Mastenbrook, MD, Neil C Hughes, MD, William D Fales, MD and David T Overton, MD of the Western Michigan University School of Medicine described an “Inexpensive Portable Pulmonary Edema Intubation Simulator” in which they adapted a previously owned commercial airway task trainer simulator using an aquarium pump, tubing, an air stone, and an endotracheal tube. Pulmonary edema solution was created with glycerin, dish soap, (distilled) water and simulated blood. The solution and air stone are placed in one of the simulator's lungs. Subsequently, turning on the aquarium air pump generates simulated pulmonary edema within the lung itself, which froths up and out of the trachea and into the hypopharynx, mimicking the gross pathophysiological process.

A company 3-DMED supplies a pitting edema palpation training model for teaching and learning hospital and nursing care procedures. This product consists of five variations of pitting edema models, including a normal scenario. Grades of the edemas are based on Mosby's Guide to Physical Examination, 7th Edition. The models can be worn on the lower thighs of a simulated patient or a training manikin.

Nasco Healthcare supplies an Edema Foot simulator designed to provide realism while practicing patient assessment skills, including observation of swelling of the foot. Edema simulation can be practiced by pressing on the surface of the skin of the simulator. The simulated foot uses lifelike simulated tissue pads to demonstrate Stages 1+ through 4+, as well as a non-pitting stage of edema known as brawny edema. Pressing on the surface of the skin may leave an indentation that does not immediately rebound when pressure is released, or it may not indent under pressure, depending on which tissue pad is placed in the foot simulator. A Deep Tissue Injury simulation is also present on the heel of the foot simulator. The foot simulator attaches to select Patient Care Manikin. Five interchangeable pads representing one non-pitting stage and four pitting stages of edema are present.

Edema simulators have been developed to avoid expensive simulation mannequins. Conventional edema simulation devices are used to emulate how edema feels when palpated and visually how it will present in patients. Problems with these conventional edema simulation devices are the use of inaccurate materials to simulate tissues, biologically dissimilar methods to create simulated edema and limited compatibility for use in simulation mannequins or human users. This lack of clinically similar edema simulation results in inadequate education of nurses, doctors, students and other healthcare professionals in identification/staging of edema.

Edema simulators which create edema in a dissimilar way to how it happens naturally will educate users to assess patients with incorrect techniques and poor overall experience quality.

There is a need to effective efficient edema simulator that emulates clinically similar edema in a pathologically similar way to how swelling occurs biologically

### SUMMARY OF THE INVENTION

The various embodiments and examples of the present invention as presented herein are understood to be illustrative of the present invention and not restrictive thereof and are non-limiting with respect to the scope of the invention.

One aspect of the invention provides An edema simulation device comprising of:
a. four thin flexible polymer bags;
b. A skin-simulating outer coupled to each of the polymer bags;
c. A permeable foam inner layer within each of the bags; and
d. A fluid or gel within each of the bags, wherein the edema simulation device is configured to simulate four stages of edema, with one bag simulating each stage.

One aspect of the invention provides an edema simulation device comprising of:
a. A thin flexible polymer bag;
b. A skin-simulating outer coupled to the polymer bag;
c. A permeable foam inner layer within the bag; and
d. A fluid or gel within the bag, wherein the edema simulation device is configured to simulate at least one of four stages of edema.

The present invention provides an edema simulation device that emulates clinically similar edema in a pathologically similar way to how swelling occurs biologically in tissues while also creating edema that feels and presents more similarly to that of real patients. This device comprises a layer of artificial skin on top of a bag containing foam and a fluidized substance formed of a fluid and/or gel. It works by pumping a fluidized substance into a sealed plastic bag or flexible pouch that contains a foam material. This foam material is to emulate tissue and the fluid and/or gel emulates the blood and biological fluids contained in the tissue. The device simulates the four degrees of edema by how much fluidized substance is removed or added into the bag. When there is no edema present, the fluidized substance will be sucked out of the bag leaving the foam compressed by the vacuum and holding only the normal amount of fluidized substance found in non-edematous tissues. As fluidized substance is pumped into the bag, the foam swells representing the fluid being retained in the tissue and edematous tissue.

A measured delivery device such as a syringe with edema degree increments, will be used to add/remove the fluid via a valve connected to a flexible tube leading to the bag/pouch. Some embodiments can include differing shapes of the bag/pouch such as circles, rectangles, squares, triangles, hexagons and octagons, based on the body location the device is placed. Some embodiments include any foam or foam like material that allows fluidized substance (formed of fluids and/or gels) to perfuse through the foam. Some embodiments can include differing shapes of the foam such as circles, rectangles, squares, triangles, hexagons and octagons, based on the body location the device is placed. Some embodiments can include any valve that allows a syringe to remove/add fluid to the device.

Some embodiments can form the fluidized substance to include any fluid and/or gel that acts characteristically similar to water and blood being pumped/removed from the bag and foam. Further the fluidized substance may be ambient temperature, elevated body temperature or even colder than ambient, depending upon the application.

Some embodiments can allow for differing skin pigment colorations added to the artificial skin like layer including light, medium and dark skin tones. Some embodiments can include any thin plastic sheeting made from any polymer to be used for the bag/pouch used to cover the top layer of the artificial skin. Some embodiments can include differing thicknesses of the bag/pouch sheeting, emulating elastic deformation of very thin to very thick skin. Some embodiments can include varying thicknesses of the artificial skin layer to accurately replicate thin and thick skin. Some embodiments include fluids and/or gels that contain pigments similar to those found in bodily fluids and blood.

Some embodiments can include a dynamic model that can be altered as described above via fluid removal or addition. Some embodiments can include a static model with prefilled bags for each stage of edema for quick comparison.

Some embodiments can include strap adaptors or adhesive backing that allow for the device to be attached to both simulation mannequins table top displays and human users. Some embodiments can include using electronic pumps to control swelling and fluid movement in the foam and bag/pouch. Some embodiments can include permeable materials that allow for the fluid/gel to perfuse through the material to the surface. Some embodiments can include varying foams of different densities and material compositions. Some embodiments can include four pre-sealed bags/pouches in a display box featuring the four stages of edema. This pre-sealed display would be for purposes in easily training users to compare differing stages of edema without having to adjust fluid amounts.

These and other advantages of the present invention are described below in connection with the attached figures in which like reference numerals represent like elements throughout.

### BRIEF DESCRIPTION OF THE FIGURE

FIG. 1 schematically illustrates an edema simulation device according to one embodiment of the present invention that emulates clinically similar edema in a pathologically similar way to how swelling occurs biologically in tissues, and illustrates needed accessories involved in emulation of edema stages.

FIG. 2 schematically illustrates a perspective view of the edema simulation device according to FIG. 1 in a rectangular shape.

FIG. 3 schematically illustrates a perspective view of a modified version of the edema simulation device according to FIG. 1 in a square shape.

FIG. 4 schematically illustrates a perspective view of a modified version of the edema simulation device according to FIG. 1 in a circular shape.

FIG. 5 schematically illustrates a perspective view of a modified version of the edema simulation device according to FIG. 1 in a triangular shape.

FIG. 6 schematically illustrates a perspective view of a modified version of the edema simulation device according to FIG. 1 in a hexangular shape.

FIG. 7 schematically illustrates a perspective view of a modified version of the edema simulation device according to FIG. 1 in an octagonal shape.

FIG. 8 schematically illustrates a cross sectional view of the layers that comprise the edema simulation device according to FIG. 1.

FIG. 9 schematically illustrates a rear perspective view of the edema simulation device according to FIG. 1 that will feature a sticky adhesive layer to attach to mannequins or to attaching devices for edema simulation.

FIG. 10 schematically illustrates a rear perspective view of an edema simulation device according to the present invention that further includes straps to attach to a manikin or to human simulated patients during edema simulation.

FIG. 11 schematically illustrates the edema simulation device according to FIG. 1 being palpated with the material deflecting or dimpling only slightly showcasing a stage one edema level.

FIG. 12 schematically illustrates the edema simulation device according to FIG. 1 being palpated with the material deflecting or dimpling more significantly showcasing a stage four edema level.

FIG. 13 schematically illustrates an edema simulation device according to another embodiment of the present invention that emulates clinically similar edema in a pathologically similar way to how swelling occurs biologically in tissues, where the device will feature prefilled bags/pouches with foam, artificial skin, the top sheet polymer layer set to four edema stages to be used for comparison purposes.

FIG. 14 schematically illustrates an edema simulation device according to another embodiment of the present invention that emulates clinically similar edema in a pathologically similar way to how swelling occurs biologically in tissues, where the device will feature prefilled bags/pouches with foam, artificial skin, the top sheet polymer layer set to four edema stages together with a strap holding one of the prefilled bags/pouches to a manikin or human simulated patient.

### BRIEF DESCRIPTION OF THE PREFERRED EMBODIMENTS

The present invention provides an edema simulation device or edema simulator 100 that can be used on both table top, mannequin models and human simulated patients. The device 100 gives more flexibility to institutions and hospitals who have limited funding and resources to accurately train users on edema identification and staging. Edema is an early sign of major complications like fluid retention, chronic heart failure, lung, liver and kidney disease, vascular blockage, venous insufficiency, electrolyte imbalance, improper medication administration and diet problems, making this knowledge critical in patient care. Early identification of swelling/staging of edema is a critical skill to have in prevention of negative patient outcomes.

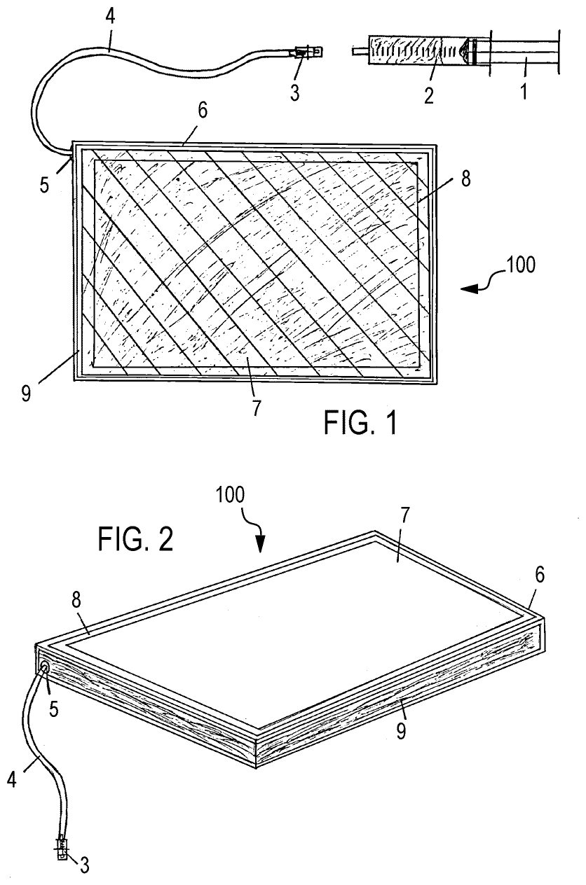

Disclosed herein is an edema simulator 100 that is comprised of an artificial skin layer 8 on top of a thin flexible bag/pouch 6 containing a foam material 9 which simulates the multiple degrees of edema when fluid is present in various amounts. The fluid may be added/removed to the flexible bag 6 via use of a syringe 2 to adjust fluid amounts for adjusting the stage edema being simulated. This embodiment of the device 100 is shown in FIGS. 1-9 and 11-12, and this syringe modified device 100 allows for a single unit to simulate the four degrees of edema.

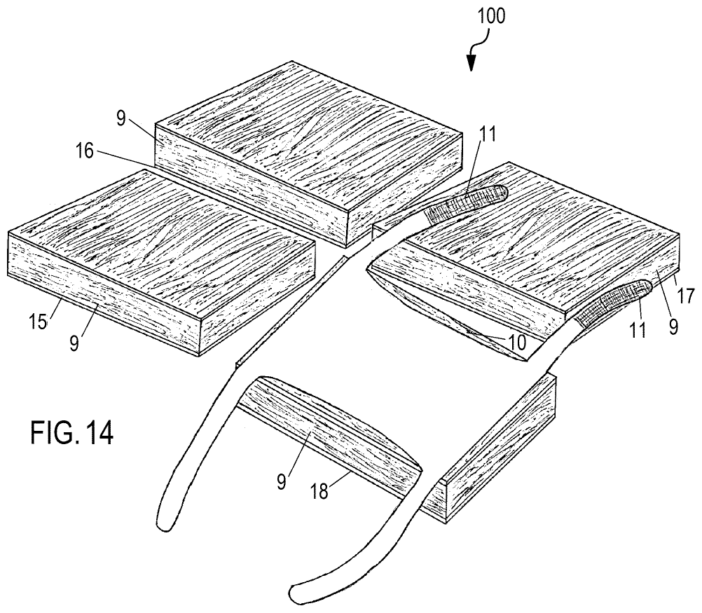

An alternative edema simulator 100 is shown in FIGS. 13 and 14. The device of FIGS. 13 and 14 are still using foam 9, artificial skin layer 8 and fluid but it's not using a syringe 2 to change the fluid amount (edema stage) to vary. It's now just 4 sealed packs 15, 16, 17 and 18 each with the foam 9, artificial skin 8 and fluid corresponding to each edema stage. These packs 15, 16, 17 and 18 may couple to a human attachment strap 12 which can attach to an adhesive layer 10 on the back side as shown in FIG. 14 or may be slipped into a fitted sleeve or pocket formed in the attachment strap 12 to hold them on the mannequin or human simulated patient.

The edema simulator 100 of the present invention provides a more clinically similar presentation and feel to a training model and replicates the biological fluid retention process in tissues. The device 100 is a better representation of true clinical edema being that it is producing the swelling using a process similar to how it biologically happens.

As outlined above in the background, most conventional edema simulators consist of silicone block or similar materials of differing hardness's, to emulate different edema degrees. The disclosed device 100 will not only create more clinically similar edema via a process similar to the natural body but will be compatible with table top use, simulation mannequin use, or even human simulated patient use, unlike most conventional prior art edema simulation devices.

As disclosed herein, the described device 100 can have many different shapes, sizes, foam harnesses', simulated fluids, simulated skins 8, plastic thicknesses and attachment options. The bag 6 containing foam 9 and fluidized substance can be made from varying thicknesses of soft, thin or thick plastic or polymers. The foam 9 inside the bag 6 can be made from many different soft, compressible materials that allow fluid or gel to perfuse through while retaining a tissue like feel.

Many different fluids and/or gels can be used to form the fluidized substance to simulate the swelling containing a variety of colorings, pigments or dye to reflect biological fluids. The device 100 and its features described herein will allow for a way to emulate clinically similar edema in a process that is reflective of the biological process involved in edema/swelling in tissues while being compatible with both table top, simulation mannequin and human simulated patient training.

In some embodiments, additional features can be included, such as simulated blood, skin colored bags, tissue colored foam, organ shaped bags and foam, electronic control of fluid flow, differing adherence or attachment methods.

The embodiments of the device 100 disclosed herein can include any one or more of the following features and/or other features:
1. Multiple shapes of bag/pouch 6 containing fluid or gel and foam 9 for accurate simulation of edema in differing body regions.
2. Multiple shapes of the foam 9 inside of bag 6 for simple and complex geometry of tissue from varying body regions.
3. Four versions of foam 9 and fluid in four bags 15, 16, 17 and 18 custom formulated to accurately simulate each stage of edema and that stages related properties.
4. Multiple sizes of bag/pouch 6 and foam 9 for simulation of acute small swelling and chronic larger swelling.
5. Varying thickness of plastic sheet 7 to vary differing skin thicknesses found in the body.
6. Varying thickness of artificial skin 8 to vary differing skin thicknesses found in the body.
7. Translucent plastics (for layers 8 and 7) to allow visualization of fluidized substance perfusion through bag/pouch 6 and foam material 9.
8. Electronic systems to control flow of fluid in bag 6 and foam 9 to implant in to simulation mannequins.
9. Electronic system that can simulate fluid shifts when specific disease, conditions or drugs and drug amounts are given.
10. Varying artificial skin layers 8 from a variety of silicone, gelatin, fibrous and elastic materials to better replicate natural skin.
11. Varying flexible sheet plastic layers 7 from a variety of materials used on top of the artificial skin layer 8 to create a skin like feel.
12. Use of artificial blood, simulated blood and other fluids that interact with the bag and foam like natural blood and bodily fluids.
13. Disinfect and reusable.

The disclosed embodiments of device 100 can provide any one or more of the following advantages over conventional edema simulation devices:
1. Biologically similar fluid retention process providing more realistic edema.
2. More clinically similar feeling emulated edema due to similar layering of artificial skin 8 and plastic 7 to that of real skin.
3. More clinically similar visual characteristics of edema due to pigments, and simulated blood.
4. Ability to warm or cool device to give a more similar temperature to a living human and emulate cool edema or warm edema and phlebitis.
5. Clearer education on fluidized substance perfusion through tissues and bodily membranes.
6. Improved user confidence in assessing and staging clinical edema in the field.
7. Ability to be used for simulation mannequin scenarios in many regions of the body.
8. Ability to learn how drugs, disease or specific conditions can affect the amount of fluid retained or removed from the body/tissues.
9. Ability to be used on table tops for training and educational purposes.
10. Ability to be used on human users for training and educational purposes.
11. Greater adoption of edema simulation devices 100 and simulation importance.
12. Decreased product cost due to use of simple and easy to modify/manufacture materials and widely commercially available materials.
13. Education of edema for all experiences levels and backgrounds with a minimal learning curve.
14. Low cost way to emulate edema without use of simulation mannequins in resource and funding lacking environments or institutions.
15. Easy to carry and transport.
16. Improved quality of training in edema identification and staging.
17. Inclusion of diversity via multiple skin pigment skin layers.

FIG. 1 shows the top view of the device 100 accompanied by a syringe 2 used to adjust the amount of fluid or gel thereby adjusting the edema degree. Starting with the syringe 2 and syringe plunger 1 the fluid or gel will be held in the syringe 2. The syringe 2 will have markers that gauge the four stages of edema by have staged increments shown on the barrel of the syringe 2. The syringe 2 will be connected to valve 3 in order to transfer the fluid or gel to the pouch/bag 6.

The fluidized substance (a fluid and/or gel substance) from syringe 2 will flow through a flexible tubing 4 that is connected via a port 5 to the bag/pouch 6. Once the fluid or gel enters bag/pouch 6 it will perfuse through the foam layer 9. As fluid or gel enters the bag/pouch 6 the foam 9 will begin to swell and expand emulating the swelling of edema in the body.

On top of the bag/pouch 6, is the artificial skin layer 8. On top of the artificial layer 8 is a thin layer of a polymer plastic sheet 7 to emulate the feel and flexibility of natural skin. The polymer plastic sheet 7 will be adhered to the artificial skin layer 8 but the artificial skin layer 8 will be placed on top of the bag/pouch 6 to allow removal for visualization of fluid or gel perfusion in bag/pouch 6.

This layering of the device 100 is to replicate the three major layers of skin in the human body. The epidermis or top layer of skin is represented by the polymer plastic sheet 7, the dermis or second layer of skin, is represented by the artificial skin layer 8 and the hypodermis or bottom layer of skin is the plastic layer of the bag/pouch 6.

The process would be the reverse of the stated steps above for removal of the fluid or gel which would decrease the stage of edema simulated in the device 100. The syringe 2 and syringe pusher 1 will be pulled backwards causing a vacuum to build thereby removing the fluid or gel from the foam 9 and bag/pouch 6 by going through the port 5 and flexible tubing 4 and finally through the valve 3, returning to the syringe 2.

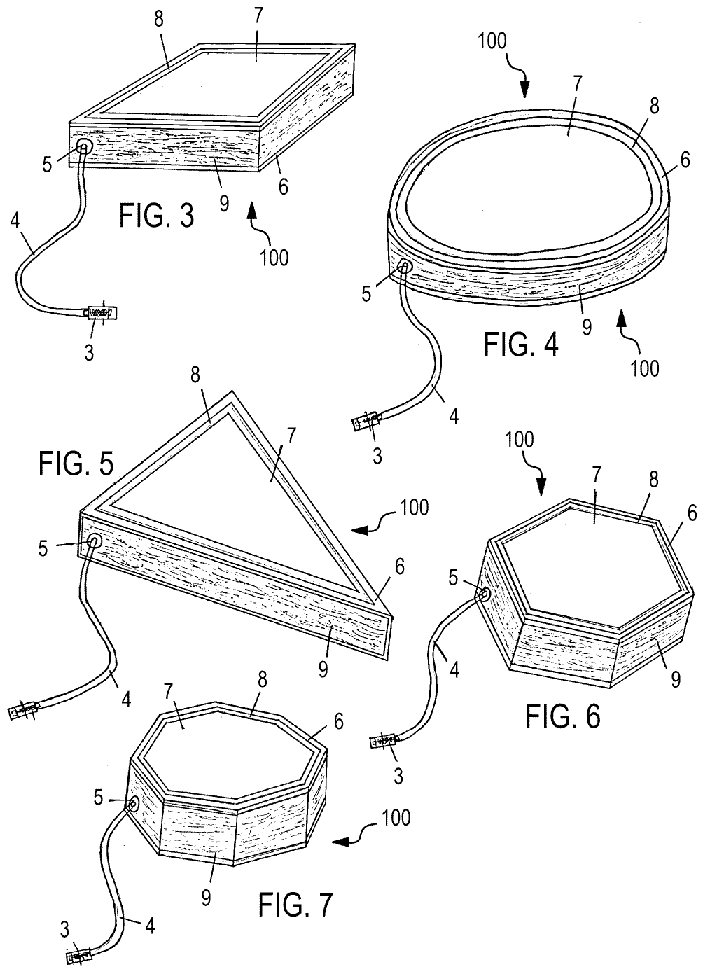

FIG. 2 shows the device 100 with a rectangular shape bag/pouch 6, foam layer 9, skin layer 8 and polymer plastic layer 7. FIG. 3 shows the device with a square shape bag/pouch 6, foam layer 9, skin layer 8 and polymer plastic layer 7. FIG. 4 shows the device with a circular shape bag/pouch 6, foam layer 9, skin layer 8 and polymer plastic layer 7. FIG. 5 shows the device 100 with a triangular shape bag/pouch 6, foam layer 9, skin layer 8 and polymer plastic layer 7. FIG. 6 shows the device 100 with a hexagonal shape bag/pouch 6, foam layer 9, skin layer 8 and polymer plastic layer 7. FIG. 7 shows the device with an octagonal shape bag/pouch 6, foam layer 9, skin layer 8 and polymer plastic layer 7. The embodiments of FIGS. 2-7 are simply to showcase the device in a specific shape. All aspects of the device 100 of FIGS. 2-7 are the same in edema emulation and stage adjustment as stated in FIG. 1.

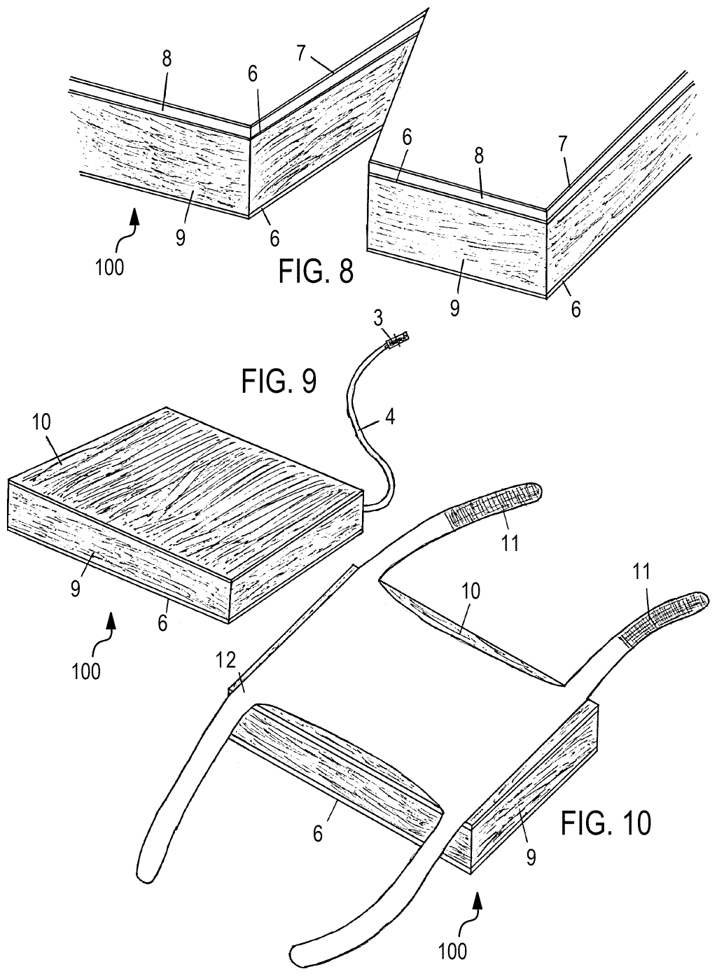

FIG. 8 shows a cross section of the layers of the device 100 with a rectangular shape bag/pouch 6, foam layer 9, skin layer 8 and polymer plastic layer 7. This figure showcases how the layers are stacked and combined together in a specific shape. The polymer plastic layer 7 will be adhered to the artificial skin layer 8. The artificial skin layer 8 will be placed on top of the bag/pouch 6 to allow easy removal to visualize perfusion and swelling of bag/pouch 6. All aspects of the device are the same in edema emulation and stage adjustment as stated in FIG. 1.

FIG. 9 shows the device 100 with a rectangular shaped bag/pouch 6, foam layer 9 and featuring the adhesive layer 10 on the back side. This adhesive layer 10 will allow for the device 100 to be attached to any portion of the simulation mannequins for edema simulation, or to a coupling device such as strap 12 shown in FIG. 10. The adhesive 10 will be made of a material that allows it to easily attach and be removed from simulation mannequins or other devices. This adhesive layer 10 will also be able to be cleaned when needed.

FIG. 10 shows the device 100 with a rectangular shaped bag/pouch 6, foam layer 9 and featuring an attachment strap 12 that will be used to attach the device to human simulated patients or to manikins. This embodiment to showcase how the attachment strap 12 will attach to the adhesive layer 10 on the back side of the device 100. The attachment strap 12 will have a smooth glossy flexible plastic surface which will interface and be attached to the adhesive layer 10. The straps 11 may feature a material like Velcro or adhesive layer to firmly attach the device 100 to a portion of the human simulated patient's body. The device 100 of FIG. 10 may be a syringe filled embodiment of FIG. 1 and operate as discussed above or may be sealed bag 15, 16, 17 or 18 filled with foam 9 and fluid simulated a fixed stage as discussed below in connection with FIGS. 13 and 14.

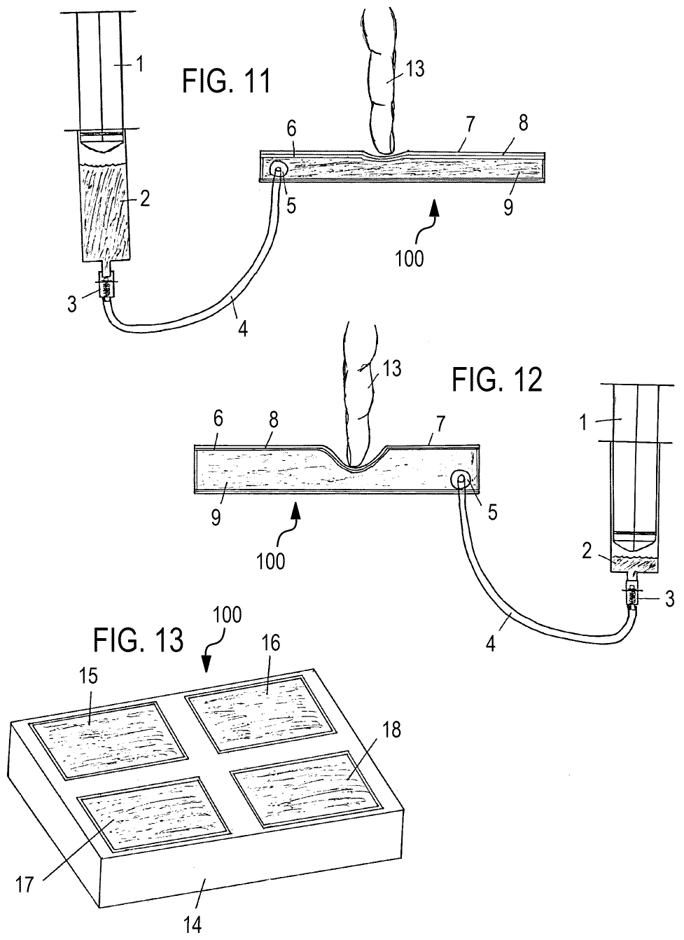

FIG. 11 shows the device 100 of FIG. 1 being palpated by a user's finger 13. The device 100 is emulating edema at stage one as seen by the dimpling of the devices layers being very minimal. The foam 9 is also shown as not being so inflated by the fluid from the syringe 2. It can also be seen how the polymer sheet layer 7, artificial skin layer 8 and bag/pouch layer 6 are interacting with the finger placing pressure on the device.

FIG. 12 shows the device 100 being palpated by a user's finger 13. The device 100 is emulating edema at stage four as seen by the greater dimpling of the devices layers. The foam 9 is also shown as being more inflated by fluid from the syringe 2. It can be also seen how the polymer sheet 7, artificial skin layer 8 and bag/pouch layer 6 are interacting with the finger placing pressure on the device.

FIG. 13 shows an embodiment of the device 100 that is to be used as a comparison tool for training and education of edema identification and staging. The display holder 14, houses four-pre-sealed bag/pouches 15, 16, 17 and 18 containing a specific amount of fluid or gel that correlates to their simulated degree of edema. Bag/pouch 15 will be filled with the proper amount of fluid or gel to emulate a degree one edema stage. Bag/pouch 16 will be filled with the proper amount of fluid or gel to emulate a degree two edema stage. Bag/pouch 17 will be filled with the proper amount of fluid or gel to emulate a degree three edema stage. Bag/pouch 18 will be filled with the proper amount of fluid or gel to emulate a degree four edema stage. All bag/pouches 15, 16, 17 and 18 will have the same foam 9, artificial skin layer 8 and polymer sheet 7 as the adjustable device 100 discussed above. The bag/pouches 15, 16, 17 and 18 are formed similar to bags 6 and will only lack a port 5, flexible tube 4 and valve 3 compared to the adjustable device 100.

This device 100 of FIG. 13 will allow users to compare the differing degrees of edema easily to each other without having to make adjustments.

These bag/pouches 15, 16, 17 and 18 will also be able to be removed from the display 14 to allow full visualization of the layers and fluid or gel perfusion in the foam 9. The bag/pouches 15, 16, 17 and 18 will also be able to be warmed or cooled in order to emulate cool edema and warm swelling more similar to human body temperature and phlebitis. FIG. 14 schematically illustrates an edema simulation device 100 according to another embodiment of the present invention that emulates clinically similar edema in a pathologically similar way to how swelling occurs biologically in tissues, where the device 100 will feature prefilled bags/pouches 15, 16, 17 and 18 each with foam, artificial skin, the top sheet polymer layer set to four edema stages together with a strap 12 holding one of the prefilled bags/pouches to a manikin or human simulated patient.

General Considerations

Characteristics, materials, and other features described in conjunction with a particular aspect, embodiment, or example of the disclosed technology are to be understood to be applicable to any other aspect, embodiment or example described herein unless incompatible therewith. All of the features disclosed in the specification (including any accompanying claims, abstract and drawings), and/or all of the steps of any method or process so disclosed may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or any novel one, or any novel combination, of the steps of any method or process so disclosed.

Although the operations of some of the disclosed methods are described in a particular sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods.

As used herein, the terms “a” and “an” encompass one or more of the specified element. That is, if two of a particular element are present, one of these elements is also of the specified element. That is, if two of a particular element are present, one of these elements is also of the specified element. As used herein, the term “and/or” used between the last two of a list of elements means any one or more of the listed elements. For example, the phrase “A, B, and/or C” means “A”, “B”, “C”, “A and B”, “A and C”, “B and C”, or “A, B, and C.”

In view of the many possible embodiments to which the principles of the disclosed technology may be applied, it should be recognized that the illustrated embodiments are only examples and should not be taken as limiting the scope of the disclosure. Rather, the scope of the disclosure is at least as broad as the full scope of the following claims. We therefore claim all that comes within the scope of these claims and their equivalents.

What is claimed is:

1. An edema simulation device comprising of:
a) A thin flexible polymer bag;
b) A skin-simulating outer coupled to the polymer bag;
c) A permeable foam inner layer within the bag; and
d) A fluid or gel within the bag, wherein the edema simulation device is configured to simulate at least one of four stages of edema.

2. The edema simulation device of claim 1, wherein the bag and foam can be one of circular, rectangular, triangular, square hexagonal or octagonal in shape.

3. The edema simulation device of claim 1, further including a thin flexible polymer layer wherein the outer artificial skin layer is covered with the thin flexible polymer.

4. The edema simulation device of claim 1, where the artificial skin layer is comprised of gelatin, glycerin and pigment.

5. The edema simulation device of claim 1, wherein the permeable foam inner layer allows the fluid/gel to perfuse though.

6. The edema simulation device of claim 1, wherein the edema simulation device is configured to simulate four stages of edema through selective transfer of fluid/gel into and out of the bag, and wherein the fluid/gel transfer will be done via a valve and syringe.

7. The edema simulation device of claim 6, further including flexible tubing extending from the syringe to the bag, wherein the flexible tubing connects to bag via a small molded port.

8. The edema simulation device of claim 7, wherein the fluid/gel are transferred via the flexible tubing to and from the syringe.

9. The edema simulator of claim 1, wherein the fluid/gel is comparable in characteristics, reaction and pigmentation to bodily fluids.

10. The edema simulation device of claim 1, wherein the device will feature an adhesive back that allows attachment of the device in a desired position.

11. The edema simulation device of claim 1, wherein the four degrees of edema can be varied by removal or addition of fluid/gel via a syringe.

12. An edema simulation device of claim 1, wherein the device is configured for macular edema simulation.

13. An edema simulation device of claim 1, wherein the device is configured for use for pulmonary edema simulation.

14. An edema simulation device of claim 1, wherein the device is configured for non-pitting edema simulation.

15. An edema simulation device of claim 1, wherein the device is configured for peripheral edema simulation.

16. An edema simulation device of claim 1, wherein the device is configured for cerebral edema simulation.

17. An edema simulation device of claim 1, wherein the device is configured for pitting edema simulation.

18. An edema simulation device comprising of:
a) four thin flexible polymer bags;
b) A skin-simulating outer coupled to each of the polymer bags;
c) A permeable foam inner layer within each of the bags; and
d) A fluid or gel within each of the bags, wherein the edema simulation device is configured to simulate four stages of edema, with one bag simulating each stage.

19. The edema simulation device of claim 18, further including a thin flexible polymer layer wherein the outer artificial skin layer on each bag is covered with the thin flexible polymer.

20. The edema simulation device of claim 18, where the artificial skin layer is comprised of gelatin, glycerin and pigment.
